(19) United States
(12) Patent Application Publication
(10) Pub. No.: US 2007/0113258 A1
(43) Pub. Date: May 17, 2007

(54) Method and system for distributing local programming to areas abroad

(76) Inventor: Michael Earle, Centennial, CO (US)

Correspondence Address: HODGSON RUSS LLP, ONE M & T PLAZA, SUITE 2000, BUFFALO, NY, 14203-2391, US

(21) Appl. No.: 11/282,758

(22) Filed: Nov. 17, 2005

(51) Int. Cl. H04N 7/16; H04N 7/173

(52) U.S. Cl. 725/131; 725/100; 725/139; 725/151

(57) ABSTRACT

There is provided an IPTV distribution system and method for distributing programming made available to viewers in a first jurisdiction to subscribers in a second jurisdiction to enable a viewing experience otherwise available only in the first jurisdiction. The programming may include signals broadcast over the air (OTA) in the first jurisdiction for redistribution to remotely located subscribers. The subscribers are resident in a jurisdiction remote from the programming and are unable to receive the programming through other means. In particular the subscribers are located in a foreign jurisdiction where current distribution networks (e.g. cable or satellite) do not offer programming obtained from foreign sources. The proposed IPTV distribution system may be used to target subscribers living abroad from their native countries and who desire local programming from such countries. By way of example, the IPTV distribution system may provide the major US networks to US citizens living in Europe. The system preferably permits subscribers to chose which programming they may receive.

### FIELD OF INVENTION

The present invention relates generally to distributing television (TV) programming and particularly to redistributing local programming to areas abroad.

### BACKGROUND OF THE INVENTION

Clearly, many people like to watch television. Viewers develop strong programming preferences and loyalties. They are quick to adapt new modes of programming delivery but demand quality service and flexibility.

Indeed, television programming is available to viewers in a variety of ways including directly through over the air broadcasts or through a distribution network. Historically, programming was received directly via analog signals broadcast over the air (OTA) to a viewer's receiving antenna coupled to a television receiver. Such programming is considered to be local programming as its reception was limited to signals originating in relatively close proximity to the receiving antenna.

Eventually distribution networks were developed. Cable television distribution providers were developed to distribute or redistribute both local and remote programming via a network of co-axial cables coupled to set-top boxes and television receivers. A cable TV head-end receives the programming signals, including local programming signals broadcast over the air, remote programming signals typically transmitted via satellite and, occasionally, programming signals generated for distribution only by cable providers. The signals are combined for transmission over the analog cable network and transmitted. Set-top boxes or cable-ready television receivers receive the analog signals and manipulate them as necessary for display by the television receiver.

Programming signals are also available to users via satellite distribution providers sometimes called direct to home (DTH). Rather than deliver signals over co-axial cable, programming signals are received at a satellite head-end, digitized and up-transmitted to one or more satellites for down-transmitting to a viewer's satellite receiving antenna. The viewer's antenna is coupled to a TV receiver via a set-top box which decodes the satellite signals for display.

Additionally, with progress in data communication infrastructure including higher speed data networks to the home and video signal digitization and compression techniques, TV programming signals may also be distributed over data networks using Internet Protocol (IP). “IPTV” thus makes television programming available to a viewer's computer display or through a set-top box or other decoder/encoder to a television receiver.

Though numerous distribution models exist to provide a TV viewer in a particular area with programming, the choice of programming offered by distribution providers is very similar. That is, in a particular local area, cable providers, DTH satellite providers and IPTV providers offer similar channel line ups: In the United States and Canada, for example, the line-up includes the major U.S. broadcast networks (NBC, CBS, ABC, FOX, PBS), cable networks (CNN, TNN, HBO, etc.), and numerous specially networks and pay per view programming not available over the air.

U.S. broadcast networks that are distributed generally comprise OTA signals obtained from an affiliate station in a city selected by the distribution network for distribution to its customers. Some distribution networks offer multiple instances of a particular network, picking up local signals across various time zones to permit a form of time shifted viewing. However, in each case, the distributed local programming is very limited. It is either the local programming otherwise available to the viewer or local programming from another area remote to the viewer and with which the viewer likely has no connection or association. A viewer's choice of US Networks and other OTA programming is thus limited.

The problem of local programming choice is even greater in other jurisdictions which are even further distant from the OTA signals. For example, OTA local programming originating in the United States is not available in France. With estimates of over six million Americans living abroad, there is a substantial market opportunity to provide content from “home” and a substantial base of people willing to pay for it. Not only will such content be of interest to expatriate Americans, it is of interest to others, particularly those who do not have any access or sufficient access to American TV.

Accordingly, there is a need for a method and system for distributing local programming to areas abroad.

### BRIEF DESCRIPTION OF THE DRAWINGS

An embodiment of the invention will now be described by way of example only with reference to the following drawings in which:

FIG. 1 is a block diagram of an IPTV network for distributing programming signals to a subscriber; and

FIG. 2 is a block diagram of set-top box for receiving IPTV programming signals in accordance with an embodiment.

For convenience, like numerals in the description refer to like structures in the drawings.

### DETAILED DESCRIPTION OF THE PREFERRED EMBODIMENT

There is provided an IPTV distribution system and method for distributing programming made available to viewers in a first jurisdiction to subscribers in a second jurisdiction to enable a viewing experience otherwise available only in the first jurisdiction. The programming may include signals broadcast over the air (OTA) in the first jurisdiction for redistribution to remotely located subscribers. The subscribers are resident in a jurisdiction remote from the programming and are unable to receive the programming through other means. In particular the subscribers are located in a foreign jurisdiction where current distribution networks (e.g. cable or satellite) do not offer programming obtained from foreign sources. The proposed IPTV distribution system may be used to target subscribers living abroad from their native countries and who desire local programming from such countries. By way of example, the IPTV distribution system may provide the major US networks to US citizens living in Europe. The system preferably permits subscribers to chose which programming they may receive.

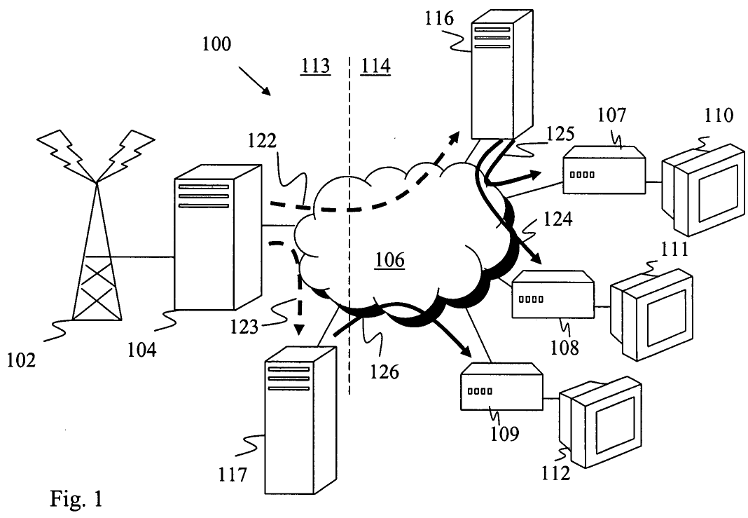

FIG. 1 illustrates a representative IPTV network (collectively 100) in accordance with an embodiment for distributing local programming to distant subscribers. There is provided a head end 102 for receiving local programming signals from at least one broadcaster and preferably a plurality of such broadcasters. Though illustrated as a receiving antennae, persons of ordinary skill in the art will appreciate that head end 102 will comprise various associated equipment similar to a cable TV head end. Moreover, head end 102 is not restricted to receiving only OTA terrestrial signals but may receive programming signals from other distribution networks including cable or satellite distribution. Head end 102 encodes the programming signals using digital signal processing techniques and known encoding standards for capturing television signals (video and audio). These standards may include MPEG standards such as MPEG4. Preferably, the head end produces an encoded signal which allows an IP-based distribution server to stream full quality, full resolution video at lower bit rates. Ideally the compression scheme is robust, tolerant, and deployable, yet priced reasonably.

More than one receiving head end (e.g. regional hubs) may be employed though only one is shown. Head ends may be located at one or more selected receiving sites to receive desired broadcasts to create a desired line-up of channels to offer to subscribers. For example, the head ends may be located at major centers throughout a country (or even the world) to pick up a variety of programming signals.

Each broadcast channel received for distribution is preferably captured in its entirety and live in real time. Each broadcast channel is preferably encoded to permit transmission, decoding and display at a sufficient quality which reproduces the quality of the original signal or is otherwise comparable to cable or satellite service.

Returning to FIG. 1, the encoded signals are provided to a distribution network component 104 for transmitting to one or more re-distribution network components (e.g. 116 and 117) for ultimate delivery to subscribers of the IPTV network. The signals are transmitted over an IP-based data communication network such as the public Internet 106 in accordance with techniques known to those of ordinary skill in the art. For example the various channels may be transmitted using streaming techniques (e.g. secure IP multicasting). It is understood that the communication network from end-to-end will require reliable high speed transmission capabilities to service quality levels expected by TV viewers.

Though illustrated as respective single components for distribution (104) and redistribution (116 and 117), persons of ordinary skill in the art will appreciate that a plurality of servers and other computer network components will be required for such tasks. For example, with respect to the task of redistributing programming signals to specific ultimate IPTV subscribers, redistribution network components may comprise authentication servers, load distribution servers, provisioning servers (for IPTV account, etc. or set-top box software), routers etc. and associated software. Web servers may also be coupled to the redistribution network to provide a subscriber interface to services offered by a redistribution network provider. The interface may facilitate management of a subscription to the service including channel line-up selection, accounting services including bill payments, etc. Further servers and components for providing optional communication capabilities to subscribers (e.g. SMS, IM and chat via TV) as described further below may also be included. Various hardware and software/middleware for broadband IPTV distribution for integration in accordance with the present embodiment may be available from Siemens AG, Compagnie Financiere Alcatel, and OpenTV, Inc.

IPTV signals in accordance with the present embodiment are redistributed by the redistribution network components 116 and 117 to subscriber set-top boxes (e.g. 107, 108 and 109) for decoding and displaying TV signals on respective TV monitors 110, 111, and 112.

IPTV signals are generated in a first jurisdiction 113 where the programming signals are received. In accordance with a business model developed to address the needs of viewers in distant places who want to view receive programming, e.g. local programming, from other places that is generally only available to viewers in the first jurisdiction, the IPTV signals are transmitted for receiving by subscribers in a second jurisdiction 114 remote from the source of the programming signals.

Signals are distributed via the data network 106 as denoted by representative distribution flows 122, 123 to a redistribution network (e.g. 116, 117). The signals are redistributed as indicated by representative redistribution flows 124, 125 and 126 for reception by respective set-top box 107, 108 and 109 where the signals are decoded and provided for display on television receiver 110, 111 and 112. Though shown being redistributed to subscriber set-top boxes 107, 108 and 109 via the public Internet 106, persons of ordinary skill in the art will appreciate that such signals may be redistributed via a private IP network (not shown) between the redistribution servers 116 and 117 and set-top boxes 107, 108 and 109.

Redistribution network components 116 and 117 may be co-located with equipment of an ISP or other service provider and are thus likely located relatively near to subscribers for the IPTV service in an area. However, such need not be the case. It is further anticipated that subscribers will subscribe to services from a particular IPTV service provider and form part of a redistribution network with such a provider. Thus a subscriber's set-top box will receive IPTV signals only from a single redistribution provider. While subscriber equipment is illustrated as a single set-top box and a single TV, an individual subscriber may have more than one set-top box for different televisions sets in a single location or may configure a home redistribution network to supply the IPTV signals to a plurality of TVs in the single location.

Captured programming signals are redistributed such as by steaming techniques to a set-top boxes in accordance with a subscriber's subscription. Thus a subscriber who has not subscribed to a particular channel is prevented from viewing that redistributed channel. Persons of ordinary skill in the art will appreciate that various techniques to prevent unauthorized viewing may be used including blocking access to the redistributed programming signals and security encoding or encrypting the programming signals but restricting their decoding by the set-top box.

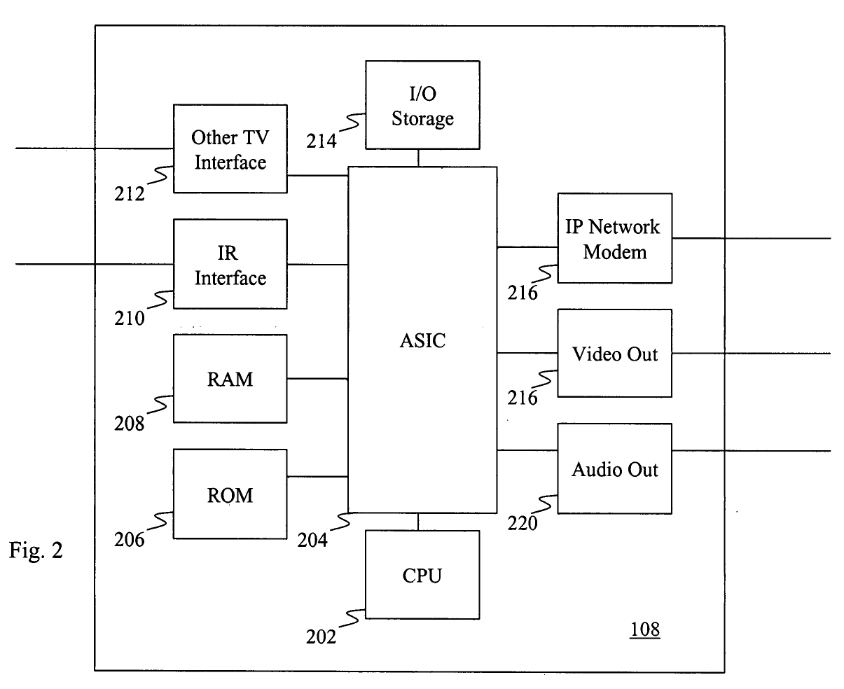

FIG. 2 illustrates a representative set-top box 108 for receiving the IPTV signals, decoding same and providing them for display on a television receiver (e.g. 111). Set-top box 108 comprises a CPU 202, ASIC 204, memory units (ROM and RAM 206, 208), an infrared (IR) interface 216 for receiving signals from a remote control device (handheld controller, keyboard or the like) for inputting viewer controls, an other TV receiving interface 212 (for example to optionally couple a receiving antenna, DVDNVCR, cable TV source output or satellite TV source output providing video signals for display by the television receiver 110), a modem 216 for coupling to an IP data network and video and audio output interfaces 218, 220 for coupling to television receiver 110 and/or audio equipment. Modem 216 is preferably a high-speed modem (e.g. xDSL, cable etc.) sufficient to receive the IPTV signals via a data network service provider (ISP). ASIC 204 provides a coupling bus for connecting the other illustrated components, under the control of CPU 202.

Set-top box 108 may also comprise an I/O storage device 214 such as a drive for magnetic disks, optical disks (CD and/or DVD), and the like. Storage device 214 can be used in a variety of ways. It can be used to input software or data to the set-top box, or to receive downloaded software or data from the IP network. Storage 214 may be used to implement a personal video recorder (PVR) device for digitally recording received programming and for playback.

Persons of ordinary skill in the art will appreciate that the set-top box is representative and that additional components may be included and others omitted. Modem 216 may be a separate component serving a viewer's home network and be replaced by a suitable network interface component (e.g. Ethernet, Wi-Fi). Set-top boxes for IPTV are available from Amino Technologies plc. for example.

CPU 202 and its memory 206 and 208 stores and executes the set-top box client software (instructions and data). The software provides IP network functions, authenticates a subscriber and decodes IPTV signals for display. Decoding may include decrypting as persons of ordinary skill in the art will appreciate that content signals are generally encrypted when transmitted via a public network. The client software may include a network browser client for communication between the subscriber and the redistribution network server(s) 104 and may further include capabilities to permit general Internet browsing by a subscriber. Electronic programming guides (EPGs) may also be facilitated through set-top box 108. Set-top box 108 may also be configured to test a potential subscriber's network connection to ensure connection speeds sufficient to receive IPTV signals for real time decoding and display.

Other network communication facilities may also be offered such as data communications between subscribers or other entities on the network. Examples include, short message service (SMS), electronic mail (email), Instant Message (IM), chat and the like. Subscribers may engage in such communication with others, especially other subscribers coupled to the service. Set-top box 108 may be adapted to provide a GUI for such communication via the TV 110. The GUI may be configured to operate even while watching a television program on the TV. A wireless keyboard may be coupled to set-top box 108 via IR interface 210 or another preferably but not necessarily wireless short distance interface, such as VHF radio or Bluetooth™ (not shown).

Set-top box 108 may further store or be coupled to software for providing the GUI and for communicating the SMS, email, IM or other messages with server 104 or another server (not shown) adapted for such communication. In still a further embodiment, voice communication may be facilitated between subscribers for example using VOIP techniques through set-top box 108 coupled to a microphone and speaker (not shown).

A person desiring to view local programming in a jurisdiction distant from where the programming source originates may subscribe to an IPTV distribution provider offering the desired channels. The subscriber (or a technician) installs a set-top box 108, coupling it to the subscriber's high-speed data communications network and television receiver 110 and electrical power. Set-top box 108 is powered-up and adapted for automatic authentication. Redistribution network servers 116 and 117 may be pre-provisioned and sufficient software enabled to direct the set-top box to connect to the re-distribution network. Subscriber data may be input as necessary to authenticate the set-top box 108 and activate the subscriber's account on the redistribution network 104. Additional or current set-top box software may be downloaded as necessary.

Preferably, the subscriber may choose local programming channels for receiving via the IPTV network. The choice may be initially facilitated at the time of subscription. Thereafter, changes may be made via the set-top box browser in communication with the redistribution network 104 or via other interfaces such as telephone (not shown). Redistribution network components (e.g. 116 and 117) preferably comprises a billing/account component for tracking a subscriber's use of the IPTV network, typically on a monthly and per channel basis. A subscriber may be charged a subscription fee for each channel the subscriber is enabled to receive during a month. The fees may vary per channel. More popular local programming channels (for example, a US network affiliate originating from New York City) may be subscribed to at a lower cost than a similar affiliate originating from Anchorage or an Australian Broadcast Corporation signal from Sydney. Preferably true “a la carte” service may be provided allowing a subscriber to pick individual programming channels.

Importantly for the business model, local programming may be offered to subscribers who are remote from the local programming source. The IPTV network facilitates serving such long distance subscribers, particularly those who may have lived in the area of the local programming but who have since moved abroad, such as Americans living outside the United States. In addition to local programming as described, other channels of programming may be offered such as specialty channel, pay per view, cable, satellite or other programming.

Consumers all over the world have long desired to have American content in their homes and to have that content delivered to their television set. Several services have entered the market that offer pre-recorded content designed to be viewed on the PC on a video on demand model. American expatriates have been longing for a taste of home in the form of television content, so much so that many have chosen to receive signals in foreign countries from American satellite providers which may be illegal. IPTV as described in accordance with the model herein will allow subscribers, outside of North America for example, to receive service to their television that will feel and behave just like traditional digital cable and satellite services: signals are distributed and redistributed in real time, for consumption at any time. International consumers will have the ability to subscribe to an entertainment service that is in their own language and is relevant to their homeland with the content that has been traditionally out of reach.

So desperate are international consumers for this content, many turn to network TV affiliates who offer archived news feeds over the Internet to be viewed on a PC screen. Distribution in accordance with the embodiments described herein puts the actual broadcast in the subscriber's home.

To serve the needs of expatriates and those resident in foreign territories and to accommodate existing content distribution relationships within the United States, the IPTV services thus described may be limited to supplying content to subscribers who are resident outside of the North American Market. Competition is stiff in the American marketplace with the top 10 cable/satellite operators enjoying over 80% of the TV subscribers in the territory. Cable and satellite operators now face impeding competition for their subscribers from telephone companies who are planning aggressive roll outs of video services over their xDSL networks. A greater potential is seen in international markets where there is no current service available. Preferably the service is offered where there is a huge demand and no current substitute.

In order to address potential legal, regulatory and other business concerns, a service providing US programming for foreign subscribers as described herein will enter content distribution arrangements with or on behalf of content owners. Restricting distribution to subscribers who are not generally provided with such content may hasten such arrangements. Offering service in international markets offers a far different model for the content owners. Distribution in accordance with the techniques described herein will allow broadcasters to increase the number of subscribers that can see their programming, thus bringing more value to the content and more value to their advertising products.

Although preferred embodiments of the invention have been described herein, it will be understood by those skilled in the art that variations may be made thereto without departing from the spirit of the invention or the scope of the appended claims.

What is claimed is:

1. A method for providing a television programming service comprising:
distributing via a public data network a plurality of programming signals available to viewers in a first jurisdiction for delivery to subscribers of the service located in a second jurisdiction, each subscriber having a set-top box for receiving the programming signals for viewing on a television coupled to the set-top box and wherein the programming signals give subscribers in the second jurisdiction a viewing experience otherwise only available to viewers in the first jurisdiction.

2. The method according to claim 1 comprising capturing the plurality of programming signals in real-time and wherein distributing comprises distributing the captured signals in real-time.

3. The method according to claim 2 wherein distribution comprises transmitting the captured signals to a redistribution network component adapted to deliver the captured signals to set-top boxes.

4. The method according to claim 2 wherein the plurality of programming signals comprises at least some local programming signals received from over the air broadcasts in the first jurisdiction.

5. The method according to claim 1 comprising controlling the viewing of the programming signals in accordance with respective subscriptions for the subscribers of the service.

6. The method of claim 5 comprising providing an interface to subscribers, accessible via a subscriber's set-top box, to manage a subscriber's subscription.

7. The method according to claim 1 wherein the first jurisdiction comprises the United States of America and the second jurisdiction is located outside of North America.

8. A system for providing a television programming service to a distant subscriber comprising:
(a) a head-end for capturing a plurality programming signals available to viewers in a first jurisdiction; and
(b) a distribution network component coupled to the head-end for distributing via a public data network the plurality of captured programming signals for delivery to subscribers of the service located in a second jurisdiction, each subscriber having a set-top box for receiving the programming signals for viewing on a television coupled to the set-top box and wherein the programming signals give subscribers in the second jurisdiction a viewing experience otherwise only available to viewers in the first jurisdiction.

9. The system according to claim 8 further comprising a redistribution network component for receiving the captured plurality of programming signals, the redistribution network component configured to stream the captured programming signals in real-time to subscriber set-top boxes.

10. The system according to claim 9 comprising subscriber set-top boxes and wherein each set-top box is adapted to authenticate to the redistribution network component in response to information for the respective subscriber to permit viewing of selected programming signals in accordance with the respective subscriber's subscription.

11. The system according to claim 10 wherein the programming signals comprises at least some local programming signals received from over the air broadcasts in the first jurisdiction.

12. The system according to claim 11 wherein the first jurisdiction comprises the United States of America and the second jurisdiction is located outside of North America.

13. A programmable medium having computer-executable instructions for providing a television programming service, said instructions comprising instructions to:
(a) receive via a public data network a plurality of captured programming signals obtained from signals available to viewers in a first jurisdiction; and
(b) deliver the programming signals to television programming service subscribers located in a second jurisdiction, each subscriber having a set-top box for receiving the programming signals for viewing on a television monitor coupled to the set-top box and wherein the programming signals give subscribers in the second jurisdiction a viewing experience otherwise only available to viewers in the first jurisdiction.

14. The programmable medium of claim 13 having computer-executable instructions to authenticate a particular set-top box to enable the viewing of the captured local programming signals in response to subscriber information.

15. The programmable medium of claim 13 having computer-executable instructions to provide an interface to facilitate the selecting of a channel line-up for a particular subscriber.

16. A set-top box comprising:
(a) means for receiving via a public data network redistributed programming signals obtained from programming signals available to viewers in a first jurisdiction, said redistributed programming signals made available to subscribers of a television programming service located in a second jurisdiction to enable a viewing experience otherwise only available to viewers in the first jurisdiction;
(b) means for coupling the set-top box to a television for viewing the redistributed programming signals; and
(c) means for authenticating the set-top box to permit the viewing of the redistributed local programming signals in response to subscriber information

17. The set-top box according to claim 16 comprising means for providing an interface to facilitate the selecting of a channel line-up for the subscriber to determine the redistributed programming signals to be viewed.
